(19) United States
(12) Patent Application Publication
(10) Pub. No.: US 2026/0180983 A1
(43) Pub. Date: Jun. 25, 2026

(54) Systems and Methods for UE Identification at the Access Layer

(71) Applicant: Apple Inc., Cupertino, CA (US)

(72) Inventors: Walter Featherstone, Cirencester (GB); Shu Guo, Beijing (CN); Sudeep Manithara Vamanan, Uttenreuth (DE); Mona Agnel, Guildford (GB); Haijing Hu, Los Gatos, CA (US)

(21) Appl. No.: 19/127,387

(22) PCT Filed: Nov. 7, 2022
(86) PCT No.: PCT/CN2022/130234

§ 371 Date: May 5, 2025

(51) Int. Cl. H04L 9/40; H04W 12/06

(52) U.S. Cl. CPC H04L 63/0876; H04L 63/0838; H04W 12/06

(57) ABSTRACT

Apparatuses, systems, and methods for UE identification at an access layer. An edge enabler client (EEC) of a UE may generate an edge enabler layer identifier unique to the UE. The EEC may transmit, to an edge configuration server (ECS) associated with an edge network, an authentication verification request that may include at least the edge enabler layer identifier of the EEC. The EEC may receive, from the ECS, a confirmation verifying that a core network has verified that the edge enabler layer identifier is associated with the UE and send, to the application client of the UE, a registration response indicating the edge enabler layer identifier is verified by the core network as associated with the UE. The registration response may indicate that the application client can consume services from the edge network associated with the ECS, e.g., via sharing the edge enabler layer identifier with the edge network.

### FIELD

The present application relates to wireless communications, and more particularly to systems, apparatuses, and methods for UE identification at an access layer, e.g., via an enabler layer identifier, e.g., in 5G NR systems and beyond.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (e.g., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP 2 CDMA2000 (e.g., 1×RTT, 1×EV-DO, HRPD, eHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the robustness and accuracy of transmitted and received signals through user equipment (UE) devices, e.g., through wireless devices such as cellular phones, base stations and relay stations used in wireless cellular communications.

### SUMMARY

Embodiments relate to wireless communications, and more particularly to apparatuses, systems, and methods for UE identification at an access layer, e.g., via an enabler layer identifier, e.g., in 5G NR systems and beyond.

For example, in some embodiments, an edge enabler client (EEC) of a UE may be configured to generate an edge enabler layer identifier unique to the UE. The edge enabler layer identifier may be valid for at least a duration of a registration of an application client of the UE with the EEC. The edge enabler layer identifier may be generated based, at least in part, on an edge security key and an EEC identifier (EECID) of the UE. Further, the EEC of the UE may be configured to transmit, to an edge configuration server (ECS) associated with an edge network, an authentication verification request. The authentication verification request may include at least the edge enabler layer identifier. In some instances, the authentication verification request may also include a message authentication code (MAC) generated based on the edge security key, an edge security key identifier and/or the EECID. In addition, the EEC of the UE may be configured to receive, from the ECS, a confirmation that may verify that a core network has indicated that the edge enabler layer identifier is associated with the UE. Additionally, the EEC may send, to the application client of the UE, a registration response that may include an indication that the edge enabler layer identifier is verified by the core network as associated with the UE. The registration response may also indicate that the application client can consume services from the edge network associated with the ECS.

As another example, in some embodiments, an edge configuration server (ECS) may receive, from an edge enabler client (EEC) of a UE, a first authentication verification request. The first authentication verification request may include at least the edge enabler layer identifier. In some instances, the first authentication verification request may also include a message authentication code (MAC) generated based on the edge security key, an edge security key identifier and/or the EECID. Further, the ECS may be configured to transmit, to an entity of a core network (e.g., such as network exposure function (NEF)), a second authentication verification request that may include at least the edge enabler layer identifier. In addition, the ECS may be configured to receive, from the entity of the core network, a first authentication verification response. The first authentication verification response may verify that the edge enabler layer identifier is associated with the UE. Additionally, the ECS may be configured to transmit, to the EEC, a second authentication verification response. The second authentication verification response may confirm that the edge enabler layer identifier is associated with the application client of the UE. In other words, the second authentication verification response may confirm that the edge enabler layer identifier has been logged with the network.

As a further example, in some embodiments, an application client of a UE may be configured to receive, from an EEC of the UE, a registration response. The registration response may include an indication that an edge enabler layer identifier is verified by the core network as associated with the UE. The edge enabler layer identifier may be unique to the UE for at least a duration of a registration of the AC of the UE with the EEC. In addition, the AC of the UE may be configured to share, with an edge application server (EAS) of an edge data network the edge enabler layer identifier. The edge enabler layer identifier may be shared directly between the AC of the UE and the EAS of the edge network and/or indirectly between the AC of the UE and EAS of the edge network via an application server.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, XR devices, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Tables, Figures, and Claims.

### BRIEF DESCRIPTION OF THE DRAWINGS

FIG. 1 illustrates an exemplary (and simplified) wireless communication system, according to some embodiments.

FIG. 2 illustrates an exemplary base station in communication with an exemplary wireless user equipment (UE) device, according to some embodiments.

FIG. 3 illustrates an exemplary block diagram of a UE, according to some embodiments.

FIG. 4 illustrates an exemplary block diagram of a base station, according to some embodiments.

FIG. 5 illustrates an example block diagram of a server according to some embodiments.

FIGS. 6 and 7 illustrate examples of network architecture between a UE and edge network as defined by 3GPP.

FIG. 8 illustrates an example of signaling for using a unique UE identifier at an enable layer, according to some embodiments.

FIGS. 9, 10, and 11 illustrate block diagrams of examples of methods for UE identification at an access layer, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
BS: Base Station
DL: Downlink
UL: Uplink
LTE: Long Term Evolution
NR: New Radio
5GS: 5G System
5GMM: 5GS Mobility Management
5GC/5GCN: 5G Core Network
IE: Information Element
CE: Control Element
MAC: Medium Access Control
RRC: Radio Resource Control

### Terms

The following is a glossary of terms used in this disclosure:
Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.
Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.
User Equipment (UE) (or “UE Device”)—any of various types of computer systems devices which are mobile or portable and which performs wireless communications. Examples of UE devices include mobile telephones or smart phones, portable gaming devices, laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.
Base Station—The term “Base Station” has the full breadth of its ordinary meaning, and at least includes a wireless communication station installed at a fixed location and used to communicate as part of a wireless telephone system or radio system.
Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.
Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.
3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.
Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.
Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.
Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.
Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

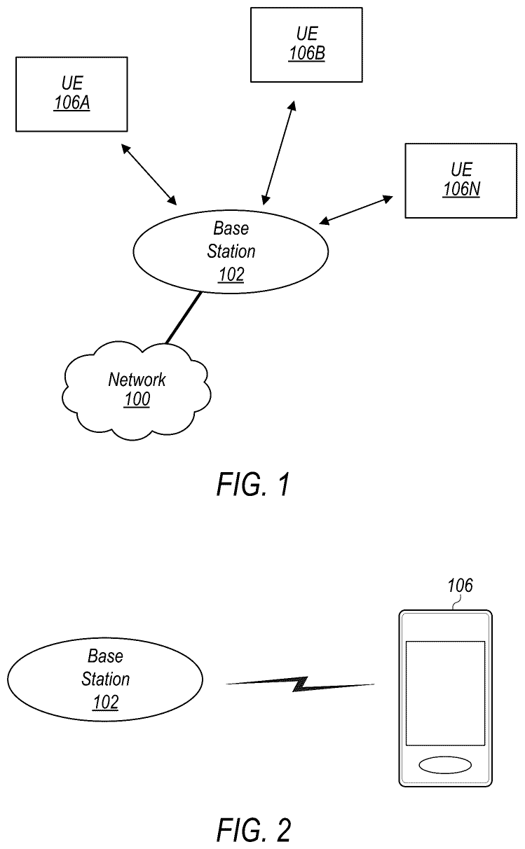

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP 2 cellular communication standard. The UE 106 may also be configured to be camped on and communicate with multiple base stations concurrently. In some embodiments, the UE 106 may be configured for CHO and XR capacity enhancements, e.g., according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein. The UE 106 may be configured to communicate using any of multiple wireless communication protocols. For example, the UE 106 may be configured to communicate using two or more of CDMA 2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH™. Other configurations are also possible.

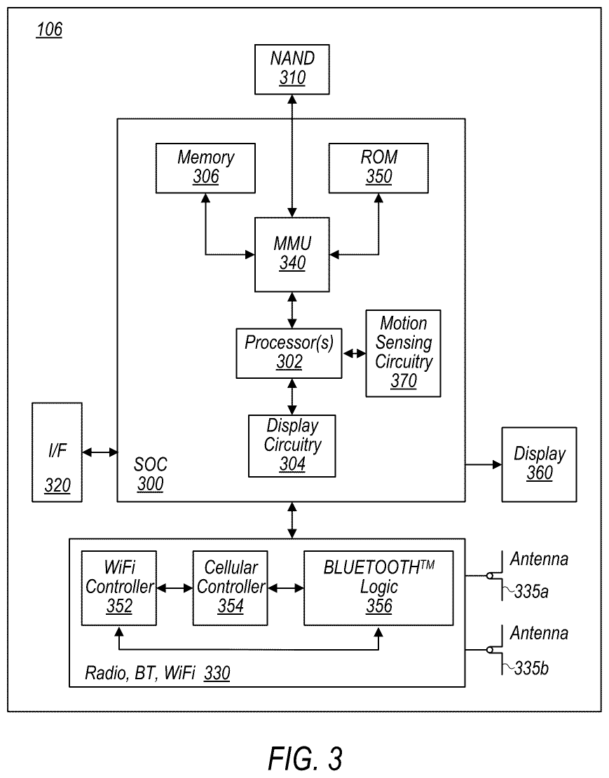

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash memory 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. As noted above, the UE may be configured to communicate wirelessly using multiple wireless communication standards in some embodiments.

The UE 106 may include hardware and software components for implementing CHO and XR capacity enhancements, e.g., according to the various methods described herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, for CHO and XR capacity enhancements, e.g., according to the various methods described herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments may have fewer or more similar controllers for various different RATs that may be implemented in UE device 106.

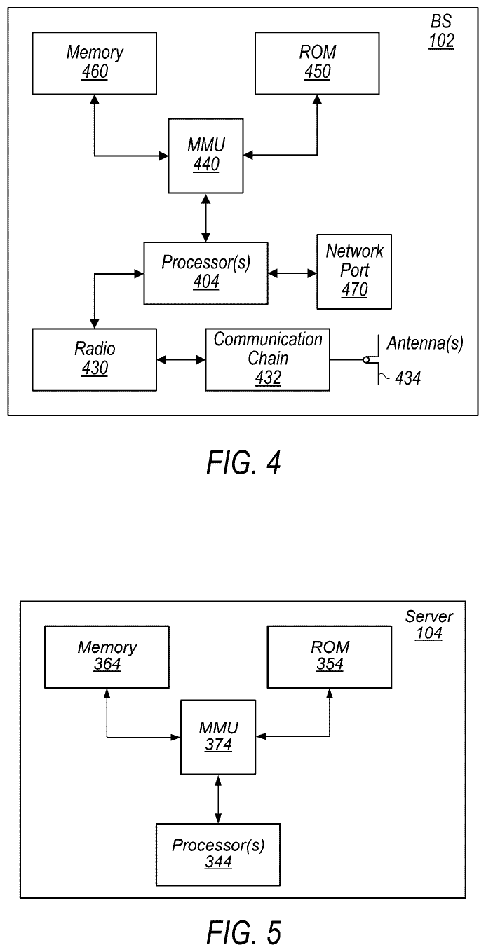

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, NR, LTE, LTE-A WCDMA, CDMA2000, etc. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may also be designed as an access point (AP), in which case network port 470 may be implemented to provide access to a wide area network and/or local area network(s), e.g., it may include at least one Ethernet port, and radio 430 may be designed to communicate according to the Wi-Fi standard. The base station 102 may operate according to the various methods as disclosed herein.

### FIG. 5: Block Diagram of a Server

FIG. 5 illustrates an example block diagram of a server 104, according to some embodiments. It is noted that the server of FIG. 5 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

### Edge Enabler Layer UE Identification

Edge computer is a distributed computing architecture that addresses limitations of centralized systems by moving data processing closer to end devices and end users. In terms of telecommunications, Mobile Edge Computing (MEC) or Multi-Access Edge Computing, provides execution resources (e.g., computation capabilities and storage) for applications with networking close to end users, e.g., typically within or at a boundary of operator networks. Edge computing can reside at enterprise premises, in transportation (e.g., vehicles, including planes, trains, and automobiles), and/or in user homes. Edge infrastructure can be managed or hosted by communication service providers or application service providers, among other entities. Benefits of edge solutions include low latency, high bandwidth, device processing and data offload, as well as trusted computing and storage.

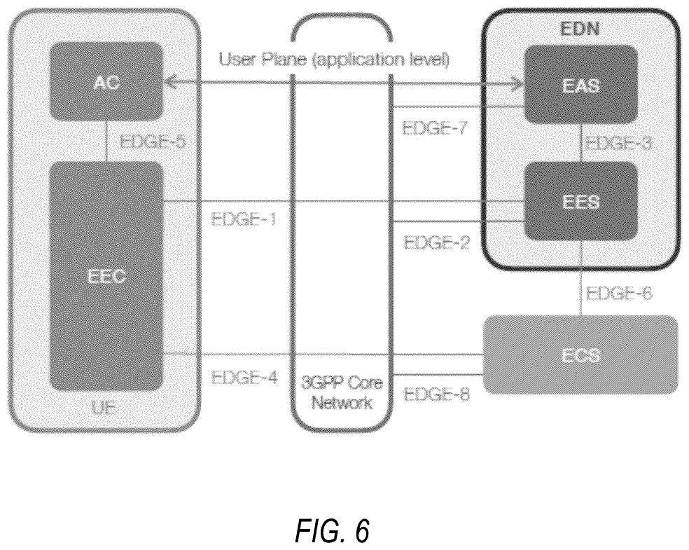

Current standards, e.g., as defined by the Third Generation Partnership Project (3GPP), specify network architecture between a UE and an edge network (EDN), e.g., as illustrated by FIG. 6. As shown, a UE may include an application client (AC) and an edge enabler client (EEC). The AC may communicate with the EEC via an EDGE-5 interface. Additionally, a 3GPP core network may support a user plane (e.g., application level) connection between the AC and an edge application server (EAS) of the EDN. The EDN may include the EAS and an edge enabler server (EES). The EAS may communication with the EES over an EDGE-3 interface. Additionally, the EAS may communicate with the 3GPP core network via an EDGE-7 interface and the EES may communication with the 3GPP core network via an EDGE-2 interface. Further, the EES may communicate with the EEC of the UE via an EDGE-1 interface. In addition, an edge configuration server (ECS) may communication with the EES via an EDGE-6 interface, the 3GPP core network via an EDGE-8 interface, and the EEC of the UE via an EDGE-4 interface.

In addition to the above-described architecture, current standards define an EEC identifier (ID) (EECID) as a globally unique value that identifies an EEC and an ACID (ACID) identifies a client side of a particular application, e.g., for a SA6Video viewer, SA6MsgClient, and so for. For example, all SA6MsgClient clients will share the same ACID. In case that a UE is running a mobile operating system (OS), the ACID may be a pair of OSId and OSAppId. This implies that the ACID is unique to an application rather than the specific instance of that application instantiated at a UE.

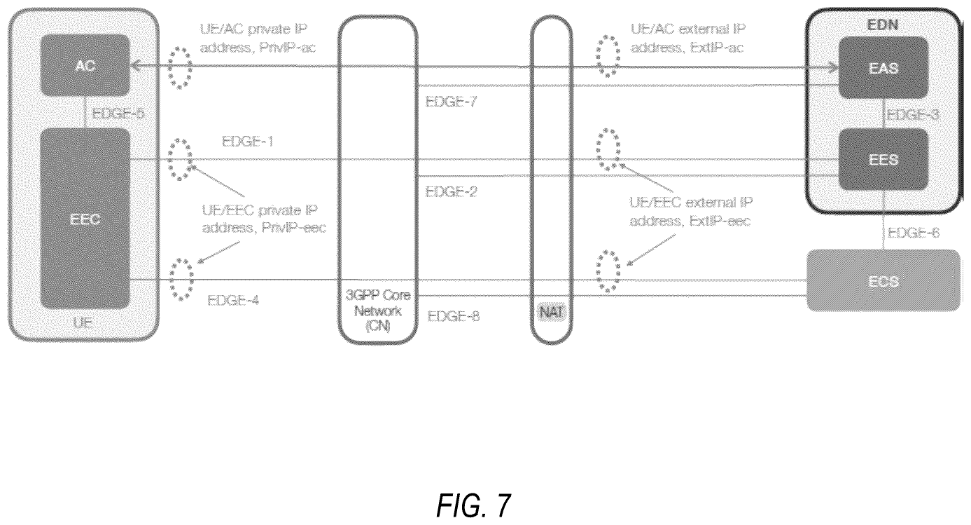

FIG. 7 provides further details regarding UE identification when communicating with an EDN via a 3GPP core network and a network address transferal (NAT) entity. As can be seen from FIG. 7, an AC of the UE may communicate with the 3GPP core network via a UE/AC private Internet Protocol (IP) address (e.g., PrivIP-ac). However, the NAT may convert that into a UE/AC external IP address (ExtIP-ac) when sending communication to the EAS. A similar scenario may occur between the EEC and the EES and/or ECS. In general, UE side identifiers may include International Mobile station Equipment Identities (IMEI), Mobile Subscriber Integrated Services Digital Network (ISDN) number (MSISDN), Subscription Permanent Identifier (SUPI) (IMSI)/Subscription Concealed Identifier (SUCI), Temporary Mobile Subscriber Identity (TMSI)/Globally Unique Temporary ID (GUTI, PrivIP-ac, PrivIP-eec, and/or EECID. Further, at the 3GPP core network, UE identifiers may include IMEI, MSISDN, SUPI (IMSI)/SUCI (encrypted SUPI)), TMIS/GUTI (temporary), PrivIP-ac, and/or PrivIP-eec as well as an external identifier (and/or MSISDN). Note that the core network may be responsible for Generic Public Subscription Identifier (GPSI)as well. At the EAS, identifiers may include an EAS ID (e.g., EASID) plus endpoint for the EAS and ExtIP-ac for the UE. At the EES, identifiers may include EESID (which may be unique within and/or to a PLMN) for the EES and ExtIP-ac (from the EAS), ExtIP-eec (from the EEC), EECID(s) and/or the UE ID (from the 3GPP core network) for the UE.

Note that although EDGE-1 and EDGE-4 procedures include UE ID (e.g., MSISDN or a token identifier), a user can choose not to provide consent for their exposure. Further, if ExtIP-ac is the same as ExtIP-eec, the EES may not link a UE's AC triggered EDGE-3 procedure to a UE's EEC connections to the EEI (e.g., at the EES/ECS). Note additionally, that interactions with the 3GPP core network (e.g., a 5G core network), e.g., EDGE-2/7/8 interfaces, require knowledge of a UE's private IP address or GPSI. Note further, that the 3GPP core network may offer a UE ID service to translate a UE's private IP address to an external identifier (non-MSISDN GPSI), e.g., an external UE ID. Additionally, if a NAT is deployed, the EAS/EEs/ECS will not inherently have access to a UE's private IP address. Thus, a UE's identity at an edge enabler level is an issue.

One proposed solution suggests usage of either (a) an MSISDN or (b) a UE or a UE's private IP address to identify the UE at the edge enabler level (EEL). However, in case (a), even if the EEC has access to the MSISDN of the UE, the EEC may not have user consent to share that with the EEL and case (b) is considered a security risk/privacy concern (particularly in the case of static IP address allocation), since internal (PLMN) LAN information is shared externally to the LAN's domain. Further, private IP addresses, particularly in the case of Ipv4 with its more limited address range, are reused meaning that they cannot guarantee to uniquely identify a UE. The proposed solution also requires creation and maintenance of a new enabler layer identifier, namely the Edge UE ID, a new AC to EAS exchange mechanism to share the Edge UE ID obtained by the AC via its associated EEC, and an expectation that the EAS can use that in its interactions with the EES (to which it is registered). However, as stated in the standard (see, e.g., TS 23.501, clause 5.20 which states that the “AF specific UE Identifier shall not correspond to a MSISDN; it is represented as a GPSI in the form of an External Identifier” and when “used as an AF specific UE identifier, the External Identifier provided by the 5GCN shall be different for different AF”), even if the EEC provides the MSISDN in the EEL, the MSISDN should not be used by the AS to identify a particular UE. Therefore, there is a motivation for a separate Edge UE ID (which may be the same as the 5GC provided External Identifier, noting GPSI is either MSISDN or External Identifier).

Embodiments described herein provide systems, methods, and mechanisms for UE identification at an access layer, e.g., via an enabler layer identifier. For example, in some embodiments, a UE may initiate a secure logging of an enabler layer managed identifier with a transport and/or access layer to allow the enabler layer at the network side to uniquely identify that UE to the transport layer when invoking transport layer procedures, e.g., such as transport layer determination of UE location, influencing (steering) of UE to application server traffic. In some instances, such a mechanism may exploit an existing identifier rather than requiring introduction and maintenance of a new UE identifier. However, in other instances, such a mechanism may use a new UE identifier. In some instances, an EECID may be used as such an identifier as 3GPP TS 23.558 defines EECID as being a globally unique identifier that refers to a specific UE hosted EEC instance.

In some instances, a UE's EEC may authenticate with a 5G core network (5GC) via an edge enabler layer (ECS) (or potentially directly). The authentication may log and/or register an EECID (e.g., a globally unique identifier of the EEC) and its association to a specific UE with the 5GC. Further, in such instances, an application client (AC) of the UE may be aware (and/or made aware) that the EECID has been successfully logged/registered with the 5GC, e.g., thereby providing an indication in an AC to EEC registration response. Additionally, the EEC may share its EECID with the AC, e.g., by providing it in the AC to EEC registration response, e.g., if the AC is not provided with the EECID during installation. In addition, the AC may share the obtained EECID with each EAS it communicates with. Each EAS may provide the EECID with its interactions with the enabler layer (EES) when invoking UE specific actions and/or may use the EECID to obtain the UE ID (e.g., the UE's GPSI External Identifier) from the enabler layer (or even the 5GC) and use that UE ID for invoking UE specific actions. In some instances, 3GPP TS 23.501 defined Network Exposure Function (NEF) UE ID service may be enhanced to accept EECID and/or an alternative service may be defined that accepts EECID and returns a UE ID.

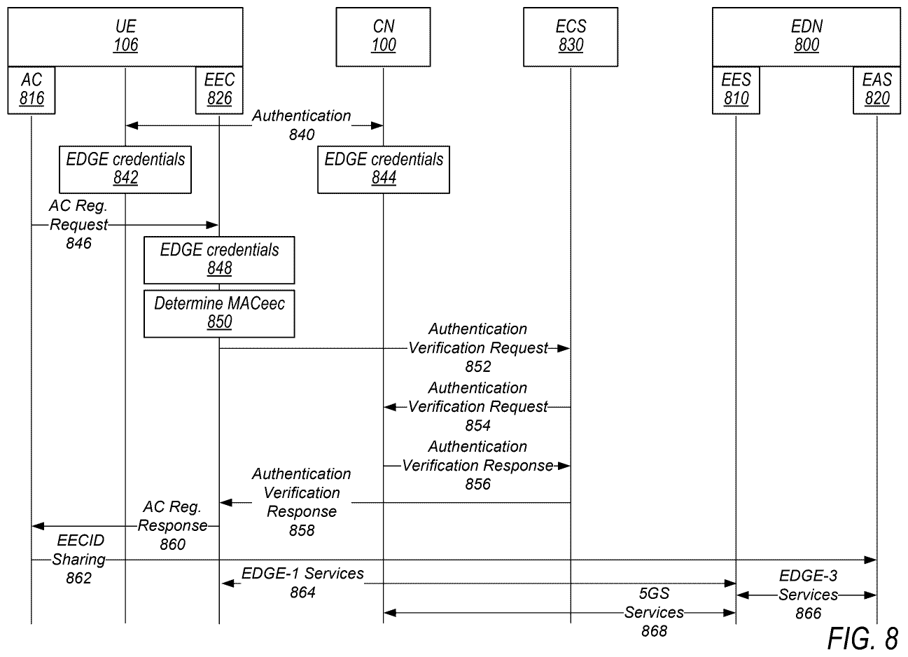

For example, FIG. 8 illustrates an example of signaling for using a unique UE identifier at an enable layer, according to some embodiments. The signaling shown in FIG. 8 may be used in conjunction with any of the systems, methods, or devices shown in the Figures, among other devices. In various embodiments, some of the signaling shown may be performed concurrently, in a different order than shown, or may be omitted. Additional signaling may also be performed as desired. As shown, this signaling may flow as follows.

A UE, such as UE 106, which may include an application client (AC) 816 and an edge enabler client (EEC) 826, may perform authentication 840 with a core network (CN), such as CN 100, which may be a 5G core network, at least in some embodiments. Thus, the UE may authenticate and establish an Authentication Server Function (AUSF) “intermediate key” (Kausf) as part of a primary authentication and key agreement procedures with the CN. Such a procedure may enable mutual authentication between the UE and the CN and provide keying material that can be used between the UE and the CN in subsequent security procedures. For example, an intermediate key, Kausf (established between the UE and home network), may be used to derive an anchor key, Kseaf, for use by the UE and Security Anchor Function (SEAF) of the CN (noting that the AUSF, which is also responsible for Kausf, provides the SEAF with Kseaf). At 842, the UE may generate an edge specific credential, such as Kedge and Kedge-ID, using the Kausf and Subscription Permanent Identifier (SUPI). For example, upon completion of the authentication 840, the UE may create edge specific credentials using the Kausf and SUPI. For example, these may be Kedge and its associated identifier, Kedge-ID, and may be generated using a key derivation function (KDF) as defined in Annex B. 2.0 of 3GPP TS 33.220. In some instances, a delegated authentication system may be utilized, e.g., such as Authentication and Key Management for Applications (AKMA), e.g., as defined in 3GPP TS 33.535. In such an instance, Kausf and SUPI may be used to generate an additional key and key identifier (such as Kakma and A-KID respectively in the case of AKMA) before using those values to generate Kedge and Kedge ID. For example, Kakma may be used in place of Kausf in the generation of Kedge and Kedge-ID. Furthermore, in such instances, an EEC ID may be used in place of the SUPI noting the use of the SUPI. Further, at 844, the CN may also generate credential Kedge & Kedge ID using Kausf & SUPI. Note that since the CN (e.g., the 5GS) also has access to the same input parameters, it (specifically the AUSF) is also able to generate Kedge and Kedge-ID.

Further, the AC may generate an AC registration request 846 and send the AC registration request 846 to the EEC of the UE. At 848, the EEC may fetch EDGE credentials, e.g., such as Kedge & Kedge-ID. For example, when required (e.g., in response to the AC registration request 846), the EEC may be able to fetch Kedge and Kedge-ID through an application programming interface (API) of the UE, e.g., the UE may make Kedge and Kedge-ID available to the EEC through the API. Additionally, at 850, the EEC may determine and/or compute a MACeec using EECID and Kedge. For example, the EEC may use Kedge plus its unique identifier (e.g., its EEC ID) to create a Message Authentication Code (MAC). This EEC specific code (MACeec) can then be used to authenticate messages sent from the EEC (e.g., check that received messages are from a particular EEC and that the message has not been tampered with) by entities with the appropriate key (e.g., the AUSF of the CN).

Hence, the EEC may transmit, to an ECS, such as ECS 830, an authentication verification request that includes the MACeec, the EECID, the Kedge-ID. The ECS may send an authentication verification request 854 to the CN utilizing services of the CN (e.g., of the 5G core (5GC) network) to perform the verification on its behalf. Typically, such requests are routed towards the network exposure function (NEF), with the ECS acting as an application function (AF) of the 5G system (5GS). “Trusted” AFs (e.g., AF deployed within the MNO's domain and/or a trusted third party) are typically permitted to connect directly to the CN network functions (NFs, e.g., the AUSF), rather than having to go via the NEF. Further, within the CN, the NEF may call the AUSF to verify MACeec using Kedge (e.g., identified using Kedge-ID) and EECID. In some instances, he ECS may interact with the NEF and may therefore send the authentication verification request 854 to the NEF. In turn, the NEF may then call upon the AUSF to verify MACeec. The AUSF may use the Kedge-ID to identify the appropriate Kedge to perform the verification. Then, if the MAC generated by the AUSF using the Kedge matches the MAC received in the verification request, the message, and therefore the EECID, is considered verified. Upon successful verification, the CN may then be able to maintain a mapping between EECID and Kedge/Kedge-ID (e.g., at the AUSF). Further, the AUSF may provide an authentication verification response 856 (e.g., indicating verification success and/or verification failure) to the ECS via the NEF. Then, assuming and/or upon successful verification, the ECS may forward an authentication verification response 858 to the EEC. Additionally, upon receipt of the authentication verification response 858, the EEC may provide an AC registration response 860 that may indicate whether the EECID has been logged with the CN (either explicitly or implicitly, e.g., only providing a successful AC registration response if logging has been performed). Note that in some instances, an early response may be provided to the AC to indicate that the registration/logging is “in progress” followed by confirmation that registration/logging is complete. This can be referred to as asynchronous operation, where support could be provided for the AC to check on the status of its registration by polling the EEC for an update.

In some instances, by tying AC registration to EEC authentication, an AC instance specific EECID may be used (which could still be globally unique, e.g., not shared with any other EEC instance). The EEC authentication could also be performed independently to AC registration and performed prior to any such AC registration. However, whichever approach is used, a mechanism is may be required to inform the AC that the EECID has been successfully “logged” with the CN prior to the AC sharing an EECID with an EAS, such as EAS of 820 of an EDN, such as EDN 800.

Once successful “logging” is verified by the AC, the AC may share the EECID with the EAS at 862 (directly or indirectly via a central AS) after service provisioning (EEC-ECS) and EAS discovery (EEC-EES). In other words, once the AC has confirmation that the EECID has been logged with the CN, the AC may share that identifier with the EAS(s) to which it is connected. Alternatively, the EAS could initiate a request to the AC for the EECID. Such a request could then be used by the AC to trigger the EEC into performing EECID authentication verification with the CN. In either case, the exchange could be via direct communication or alternatively via a centralized application server (AS). Importantly, it is critical that the EECID is successfully logged with the CN before an edge enabler layer (e.g., EEC) attempts to invoke any UE specific procedures, e.g., such as an AF specific UE ID retrieval procedure specified in clause 4.15.10 of 3GPP TS 23.502.

Note that logging of the EECID with the CN is not strictly necessary for exchanges over EDGE-1 (e.g., EDGE-1 services 864), the EEC to EES reference point. However, EEC authentication between the EEC and ECS (over the EDGE-4 reference point) is considered to be mandatory prior to establishment of the connection between the EEC and a particular EES. Once EEC authentication has been established, the EEC can utilize the services offered by the EES with the UE being identifiable through the EECID. However, it should be noted that the EECID needs to have been logged with the CN to enable the EES to invoke UE specific requests originating from the EAS.

Note further that once the EAS has obtained the EECID it is able to invoke the UE specific EDGE-3 (EAS to EES reference point) offered services 866. The EAS will have available to it the AC's public IP address. However, it cannot be sure the EES will be able to map that IP address to specific UE. Use of the EECID gives it that assurance, but only once the EECID has been logged with the CN. Note that EDGE-3 offered services may not require identification of a specific UE, e.g., a request for the current system time.

Further, the EES may invoke system (e.g., 5GS) services 868 including “UE ID” obtained from call NEF UE ID service with enhancement to accept EECID. For example, current AF specific UE ID retrieval procedure specified in clause 4.15.10 of 3GPP TS 23.502 relies on the AF (e.g., EES acting as an AF) providing a UE's private IP address. However, with the EECID logging with the CN through EEC authentication approach, the UE ID retrieval procedure may be enhanced to accept the EECID in place of a UE's private IP address. In this manner the EECID can be used by the EES to retrieve a UE's ID (e.g., Generic Public Subscription Identifier (GPSI) as external identifier, since the NEF may not expose a UE's MSISDN as an external identifier). Then in subsequent UE specific transactions, the UE ID could be used, e.g., the NEF offered UE location service that requires the UE's GPSI as input, e.g., as specified in clause 5.2.6.21 of 3GPP TS 23.502.

In some instances, there may be security concerns in sharing an EECID outside of an edge enabler layer when considering that a globally unique EECID could be used to identify a specific subscriber. Thus, in some embodiments, an EECID may be created (e.g., by an EEC or an external entity) on a per AC registration basis such that a EECID persists only for a duration of an AC to EEC registration. For example, the EEC could generate its EECID as a Universally Unique Identifier (UUID). Thus, an AC to EEC registration may persist only whilst a user is actively using the AC. As another example, in some embodiments, an EEC to AC registration response may include a temporary identifier (e.g., in place of the EECID). The temporary identifier may be provided by the EEC. The AC may then share the temporary identifier with the EES, e.g., during EAS discovery. The EAC may then provide the temporary identifier when invoking EDGE-3 services. Note that since the EES would already be aware of a mapping between an EECID and the temporary identifier, the EES would be able to provide the appropriate EECID when invoking the services of the CN.

In some instances, credential generation may use steps as defined in Annex B.2.0 of 3GPP TS 33.220. In some instances, a length of a Kedge and Kedge-ID may be specified (e.g., 128 bits each of the derived key) or Kedge and Kedge-ID may be generated separately.

Note that 3GPP does not specify how the EECID is managed, e.g., how EECID is ensured to be globally unique and what entity assigns the EECID. Thus, in some instances, an EEC may generate its own EECID, e.g., generated as a UUID for which no centralized authority is required for administration. In other instances, the EECID may be allocated via a central authority. However, in either instance, there may be trust issues regarding the EECID provided to the EAS by the AC, specifically how to ensure the EECID provided by an AC is truly associated with the EEC to which the AC is registered to on a specific UE. In some instances, to overcome this trust issue, a mechanism may be provided to enable an EAS to authenticate the EECID provided by the AC. For example, by a central authority in the case that the EECID is allocated by a central server or with the EEL itself. In order for an ECS to provision an EES to an EEC (e.g., to provide its endpoint connection information), that EES may register to the ECS. Note that if an authentication verification procedure is performed between the EEC and a particular ECS, implementations may be limited to those EES that have registered to that ECS, e.g., a EES not registered to that ECS may not be able to take advantage of the EECID logging within the CN.

As indicated above, in some instances, a UE and an AUSF (e.g., network) may derive Kedge and Kedge-ID independently. For example, each of the UE and the AUSF may use a key derivation function (KDF) to generate Kedge and Kedge-ID. Thus, at each entity, the KDF may be run once to generate Kedge and a second time to generate Kedge-ID. The KDF may use the same key (e.g., Kausf and SUPI) but different PO (e.g., A-KID at the UE and AKMA at the AUSF).

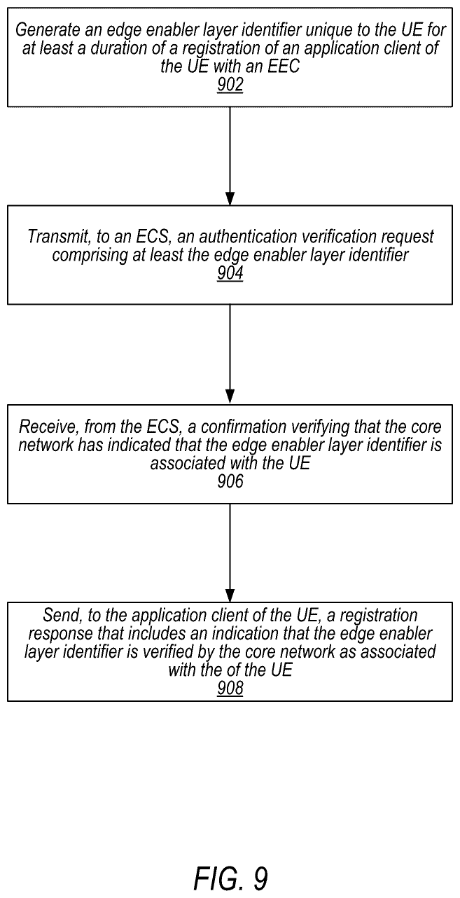

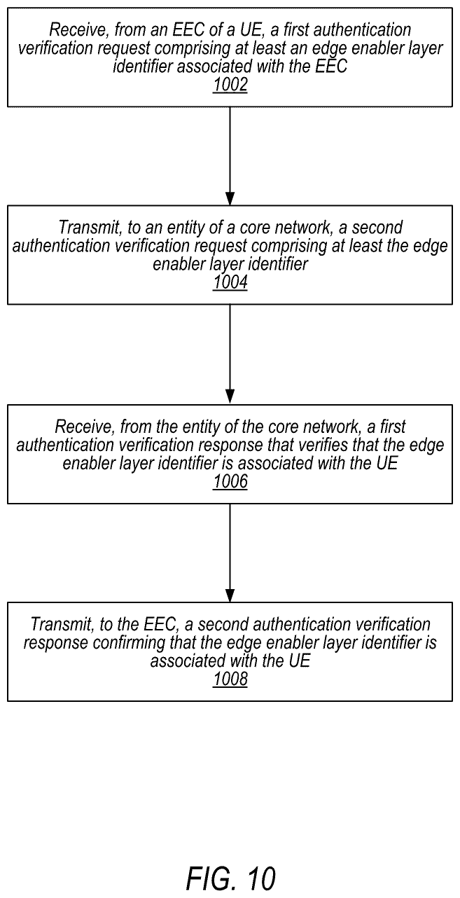

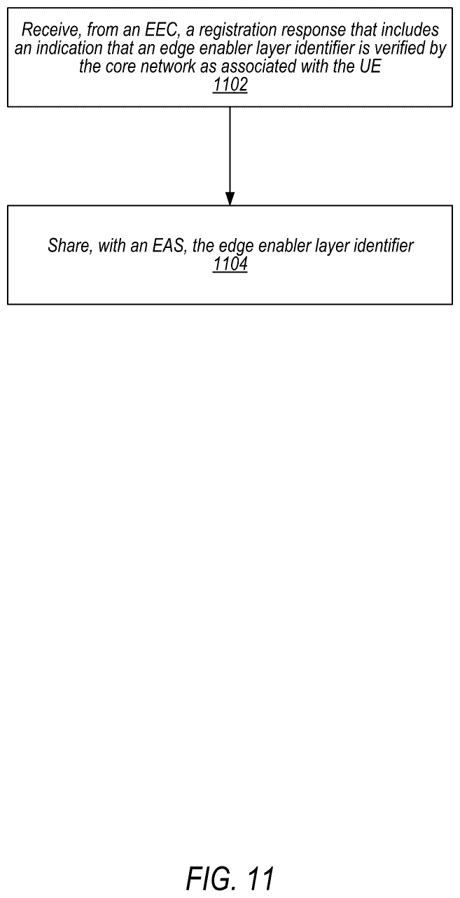

FIG. 9 10, and 11 illustrate block diagrams of examples of methods for UE identification at an access layer, according to some embodiments. The method shown in FIGS. 9, 10, and 11 may be used in conjunction with one another as well as with any of the systems, methods, or devices shown in the Figures, among other devices. In various embodiments, some of the method elements shown may be performed concurrently, in a different order than shown, or may be omitted. Additional method elements may also be performed as desired. Note that FIG. 9 is from the perspective of the UE, e.g., from the perspective of an EEC of the UE, FIG. 10 is from the perspective of an edge network, e.g., from the perspective of an ECS of an edge network, and FIG. 11 is from the perspective of the UE, e.g., from the perspective of an AC of the UE.

Turning to FIG. 9, as shown, this method may operate as follows.

At 902, an edge enabler client (EEC), such as EEC 826, of a UE, such as UE 106, may generate an edge enabler layer identifier unique to the UE. The edge enabler layer identifier may be valid for at least a duration of a registration of an application client of the UE with the EEC. In other words, the edge enabler layer identifier may be a globally unique identifier associated with the UE, e.g., only for use by the UE as an identifier. In some instances, the EEC may receive, from the application client, a registration request that triggers the generation of the edge enabler layer identifier unique to the UE.

In some instances, the edge enabler layer identifier may be generated based, at least in part, on an edge security key and an EEC identifier (EECID) of the UE. The edge security key and a corresponding edge security key identifier may be derived based on a Subscription Permanent Identifier (SUPI) of the UE and an Authentication Server Function (AUSF) intermediate key. In some instances, the EEC may fetch the edge security key and the corresponding edge security key identifier from another layer of the UE. In some instances, the EEC may generate the EECID and/or the edge enabler identifier as a Universally Unique Identifier (UUID). In some instances, the EEC may receive the EECID and/or the edge enabler identifier from a central authority. In such instances, the EEC may generate, based on the EECID and/or the edge enabler identifier received from the central authority, a Universally Unique Identifier (UUID) to share with the application client. In some instances, the edge enabler layer identifier may be a Message Authentication Code (MAC) specific to the EEC.

At 904, the EEC may transmit, to an edge configuration server (ECS), such as ECS 830, associated with an edge network, such as EDN 800, an authentication verification request. The authentication verification request may include at least the edge enabler layer identifier. In some instances, the authentication verification request may also include the edge security key identifier and/or the EECID. In some instances, the authentication verification request may include a message authentication code (MAC) generated based on the edge enabler layer identifier of the UE and an edge security key.

At 906, the EEC may receive, from the ECS, a confirmation verifying that the core network has indicated that the edge enabler layer identifier is associated with the UE. In other words, the confirmation may verify that the enabler layer identifier has been logged with the core network such that the core network can confirm that the enabler layer identifier is associated with the application client/EEC of the UE.

At 908, the EEC may send, to the application client of the UE, a registration response that may include an indication that the edge enabler layer identifier is verified by the core network as associated with the UE. The registration response may also indicate that the application client can consume services from the edge network associated with the ECS. In some instances, the registration response may include an identifier associated with the EEC of the UE. The identifier may be an EEC identifier (EECID) and/or a temporary identifier shared by the EEC in place of an EEC identifier (EECID).

In some instances, the EEC may encrypt the enabler layer identifier for transmission to the ECS in the authentication verification request. In some instances, the EEC may encrypt the enabler layer identifier for sending to the application client of the UE in the registration response.

Turning to FIG. 10, as shown, this method may operate as follows.

At 1002, an edge configuration server (ECS), such as ECS 830, may receive, from an edge enabler client (EEC), such as EEC 826, of a UE, such as UE 106, a first authentication verification request. The first authentication verification request may include at least the edge enabler layer identifier. Note that the edge enabler layer identifier may be valid for at least a duration of a registration of an application client of the UE with the EEC. In other words, the edge enabler layer identifier may be a globally unique identifier associated with the UE, e.g., only for use by the UE as an identifier. In some instances, the first authentication verification request may also include a message authentication code (MAC) generated based on the edge security key, a corresponding edge security key identifier, and/or the EECID. Note that in some instances, the edge enabler layer identifier may have been generated, e.g., by the EEC, based, at least in part, on an edge security key, the corresponding edge security key identifier, and/or an EEC identifier (EECID) of the UE. The edge security key and/or the corresponding edge security key identifier may be derived based on a Subscription Permanent Identifier (SUPI) of the UE and an Authentication Server Function (AUSF) intermediate key. In some instances, the EEC may have fetched the edge security key and/or corresponding edge security key identifier from another layer of the UE. In some instances, the EEC may have generated the edge enabler layer identifier and/or the EECID as a Universally Unique Identifier (UUID). In some instances, the EEC may have received the edge enabler layer identifier and/or the EECID from a central authority. In such instances, the EEC may have generated, based on the EECID received from the central authority, a Universally Unique Identifier (UUID) to share with the application client. In some instances, the edge enabler layer identifier comprises a Message Authentication Code (MAC) specific to the EEC. In some instances, the first authentication verification request may include a message authentication code (MAC) generated based on the edge enabler layer identifier of the UE and an edge security key.

At 1004, the ECS may transmit, to an entity of a core network, a second authentication verification request that may include at least the edge enabler layer identifier. The entity of the core network may be a network exposure function (NEF) and the NEF may interact with an Authentication Server Function (AUSF) of the network to verify/authenticate the edge enabler layer identifier. In some instances, the second authentication verification request may also include a message authentication code (MAC) generated based on the edge security key and the EECID.

At 1006, the ECS may receive, from the entity of the core network, a first authentication verification response. The first authentication verification response may verify that the edge enabler layer identifier is associated with the UE. Alternatively, the first authentication verification response may indicate a verification failure.

At 1008, the ECS may transmit, to the EEC, a second authentication verification response. The second authentication verification response may confirm that the edge enabler layer identifier is associated with the UE. In other words, the second authentication verification response may confirm that the edge enabler layer identifier has been logged with the network.

In some instances, the ECS may decrypt the edge enabler layer identifier after receiving the first authentication verification request. In some instances, the ECS may encrypt the edge enabler layer identifier for transmission to the core network in the second authentication verification request.

Turning to FIG. 11, as shown, this method may operate as follows.

At 1102, an application client (AC), such as AC 816, of a UE, such as UE 106, may receive, from an edge enabler client (EEC), such as EEC 826, of the UE, a registration response. The registration response may include an indication that an edge enabler layer identifier is verified by the core network as associated with the UE. The edge enabler layer identifier may be unique to the UE for at least a duration of a registration of the AC of the UE with the EEC. In other words, the edge enabler layer identifier may be a globally unique identifier associated with the UE, e.g., only for use by the UE as an identifier. In some instances, the edge enabler layer identifier is a Universally Unique Identifier (UUID). In some instances, the registration response may include an identifier associated with the EEC of the UE. In some instances, the identifier may be an EEC identifier (EECID). In some instances, the identifier may be a temporary identifier shared by the EEC in place of an EEC identifier (EECID).

At 1104, the AC may share, with an edge application server (EAS), such as EAS 818 of an edge data network, such as EDN 800, the edge enabler layer identifier. In some instances, the edge enabler layer identifier may be shared directly between the AC of the UE and the EAS of the edge network. In some instances, the edge enabler layer identifier may be shared indirectly between the AC of the UE and EAS of the edge network via an application server.

In some instances, the AC may transmit, to the EEC, a registration request. The registration request may trigger the generation of the edge enabler layer identifier unique to the UE. In some instances, the AC may encrypt the edge enabler layer identifier for sharing with the EAS of the edge network.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for user equipment (UE) identification at an access layer, comprising:
an edge enabler client (EEC) of the UE,
generating an edge enabler layer identifier unique to the UE for at least a duration of a registration of an application client of the UE with the EEC;
transmitting, to an edge configuration server (ECS) associated with an edge network, an authentication verification request comprising at least the edge enabler layer identifier;
receiving, from the ECS, a confirmation verifying that a core network has indicated that the edge enabler layer identifier is associated with the UE; and
sending, to the application client of the UE, a registration response including an indication that the edge enabler layer identifier is verified by the core network as associated with the UE.

2. The method of claim 1, further comprising:
the EEC of the UE,
receiving, from the application client, a registration request, wherein the registration request triggers the generation of the edge enabler layer identifier unique to the UE.

3. The method of claim 1,
wherein the authentication verification request includes a message authentication code (MAC) generated based on the edge enabler layer identifier of the UE and an edge security key.

4. The method of claim 3,
wherein the edge security key and a corresponding edge security key identifier are derived based on a Subscription Permanent Identifier (SUPI) of the UE and an Authentication Server Function (AUSF) intermediate key.

5. The method of claim 3, further comprising:
the EEC of the UE,
fetching the edge security key and the corresponding edge security key identifier from another layer of the UE.

6. The method of claim 3,
wherein the authentication verification request further comprises the corresponding edge security key identifier.

7. The method of claim 1, further comprising:
the EEC of the UE,
generating the edge enabler layer identifier as a Universally Unique Identifier (UUID).

8. The method of claim 1, further comprising:
the EEC of the UE,
receiving, from a central authority, the edge enabler layer identifier.

9. The method of claim 8, further comprising:
the EEC of the UE,
generating, based on the edge enabler layer identifier received from the central authority, a Universally Unique Identifier (UUID) to share with the application client.

10. The method of claim 1,
wherein the registration response includes an identifier associated with the EEC of the UE.

11.-39. (canceled)

40. A processor, comprising:
a memory; and
processing circuitry in communication with the memory and configured to perform operations including:
receiving, from an edge enabler client (EEC) of a user equipment device (UE), a first authentication verification request comprising at least an edge enabler layer identifier associated with the EEC;
generating instructions to transmit, to an entity of a core network, a second authentication verification request comprising at least the edge enabler layer identifier;
receiving, from the entity of the core network, a first authentication verification response that verifies that the edge enabler layer identifier is associated with the UE; and
generating instructions to transmit, to the EEC, a second authentication verification response confirming that the edge enabler layer identifier is associated with the UE.

41. The processor of claim 40,
wherein the first authentication verification request includes a message authentication code (MAC) generated based on the edge enabler layer identifier of the UE and an edge security key; and
wherein the edge security key and its identifier are derived based on a Subscription Permanent Identifier (SUPI) of the UE and an Authentication Server Function (AUSF) intermediate key.

42. The processor of claim 41,
wherein the first authentication verification request further comprises the edge security key identifier and the edge enabler layer identifier; and
wherein the second authentication verification request further comprises the edge security key identifier and the edge enabler layer identifier.

43. The processor of claim 40,
wherein the edge enabler layer identifier is generated as a Universally Unique Identifier (UUID).

44. The processor of claim 40,
wherein the processing circuitry is further configured to perform operations including:
decrypting the edge enabler layer identifier after receiving the first authentication verification request; and
encrypting the edge enabler layer identifier for transmission to the core network in the second authentication verification request.

45. A non-transitory computer readable memory medium storing instructions executable by processing circuitry to perform operations including:
receiving, from an edge enabler client (EEC) of a user equipment device (UE), a registration response including an indication that an edge enabler layer identifier is verified by a core network as associated with the UE, wherein the edge enabler layer identifier is unique to the UE for at least a duration of a registration of an application client (AC) of the UE with the EEC; and
sharing, with an edge application server (EAS) of an edge network, the edge enabler layer identifier.

46. The non-transitory compute readable memory medium of claim 45,
wherein the instructions are further executable by the processing circuitry to perform operations including:
generating instructions to transmit, to the EEC, a registration request, wherein the registration request triggers the generation of the edge enabler layer identifier unique to the UE.

47. The non-transitory compute readable memory medium of claim 45,
wherein the instructions are further executable by the processing circuitry to perform operations including:
encrypting the edge enabler layer identifier for sharing with the EAS of the edge network.

48. The non-transitory compute readable memory medium of claim 45,
wherein the edge enabler layer identifier is a Universally Unique Identifier (UUID).

49. The non-transitory compute readable memory medium of claim 45,
wherein the registration response includes an identifier associated with the EEC of the UE, wherein the identifier is an EEC identifier (EECID) or a temporary identifier shared by the EEC in place of an EECID.
